(19) United States
(12) Patent Application Publication
(10) Pub. No.: US 2015/0046602 A1
(43) Pub. Date: Feb. 12, 2015

(54) DATA SYNCHRONIZATION SYSTEMS AND METHODS

(71) Applicants: Myunghoon Lee, San Francisco, CA (US); Dongyun Youm, San Francisco, CA (US)

(72) Inventors: Myunghoon Lee, San Francisco, CA (US); Dongyun Youm, San Francisco, CA (US)

(73) Assignee: STACCATOTRIP, San Francisco, CA (US)

(21) Appl. No.: 14/300,331

(22) Filed: Jun. 10, 2014

Related U.S. Application Data
(60) Provisional application No. 61/864,570, filed on Aug. 11, 2013.

(51) Int. Cl. H04L 29/08

(52) U.S. Cl. CPC H04L 67/1095
USPC 709/248

(57) ABSTRACT

Embodiments disclose synchronizing a predetermined dataset with a real-time dataset, wherein the predetermined dataset and the real-time dataset may be synchronized based on time information, and location information.

### CROSS-REFERENCE TO RELATED APPLICATIONS

This application claims a benefit of priority under 35 U.S.C. §119 to Provisional Application No. 61/864,570 filed Aug. 11, 2013, which is fully incorporated herein by reference in its entirety.

### BACKGROUND INFORMATION

1. Field of the Disclosure

Examples of the present disclosure are related to systems and methods for data synchronization. Specifically, embodiments are related to synchronizing content in a predetermined dataset with content in a real-time dataset based on location and time.

2. Background

Data synchronization is the process of establishing consistency among data from a plurality of sources. Conventional data synchronization procedures are completed in different forms. One such way is file synchronization, which ensures that computer files in two or more locations are updated and copied via certain rules. To utilize file synchronization, files are downloaded to a source location, a user at the source location may update the files, and the updated files are copied from a source location to one or more target locations.

However, to use conventional data synchronization systems, a user must perform affirmative actions to merge files together or files must have the same name. Situations may arise when a user does not know that data should synchronize and/or the file name associated with data to be synchronized.

Accordingly, needs exist for more efficient and effective data synchronization systems and methods.

### SUMMARY

While planning a trip a user or a trip planner may desire to make a schedule of events, venues, museums, galleries, point of interests (POI), etc. (referred to collectively and individually hereinafter as “event”) that they desire to visit. The schedule may include content associated with each event, such as information associated with the event. For example, the content may include the historical significance of the event, things to look for, people associated with the event, hours that the event is open to the public, a cost associated with the event, etc. The schedule may also include time information corresponding to when the user should be located at the event, and location information corresponding to the location of the event.

While on the trip, the user may desire to supplement the schedule with content that is created, in-real time, while the user is at the event. Embodiments described herein are directed towards systems and methods for data synchronization, annotating, merging, amending, updating, supplementing (referred to herein after collectively and individually as “synchronizing”) based on location and time, wherein the content associated with the predetermined schedule may be synchronized to the content that is create in real-time.

In embodiments, the predetermined dataset may be associated with a calendar of events, tasks, schedule, etc. (referred to herein after collectively and individually as a “schedule”). The predetermined dataset may include content that the user or another user may desire to view at a later point in time, such as notes associated with a location, map of a site, etc. The predetermined dataset may also include time information associated with a time that the user expects to arrive at an event, and location information associated with the location of an event.

In embodiments, the real-time dataset may be associated with the predetermined dataset, and may include an update, amend, and/or supplement to a schedule of events, tasks, schedule, notes, etc. The real-time dataset may include content that the user generates while participating in an event, task, etc., such as viewing an attracting while traveling. The real-time dataset may also include time information associated with the time the user attends an event, and location information associated with the location of the event.

In embodiments, the predetermined dataset and the real-time dataset may be merged together to form a synchronized dataset responsive to the user's location and the time the user attends an event.

In embodiments, third party datasets may be merged with the synchronized data, wherein the third party datasets may be advertisements associated with the content of the predetermined dataset, the content of real-time dataset, the location of the event, and/or the time of an event.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts one embodiment of a topology for synchronizing data across datasets.

FIG. 2 depicts one embodiment of a client computing device.

FIG. 3 depicts one embodiment of a mobile computing device.

FIG. 4 depicts one embodiments of a travel server.

FIG. 5 illustrates a method for synchronizing a real-time dataset with a segment of a predetermined dataset.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments disclose systems and methods for synchronizing datasets based on time and location. In embodiments, a user may create a predetermined dataset with location information, time information, and content. Responsive to the user traveling to a location, the user may create a real-time dataset. The system may merge content within the predetermined dataset with content within the real-time dataset based on the time information and location information.

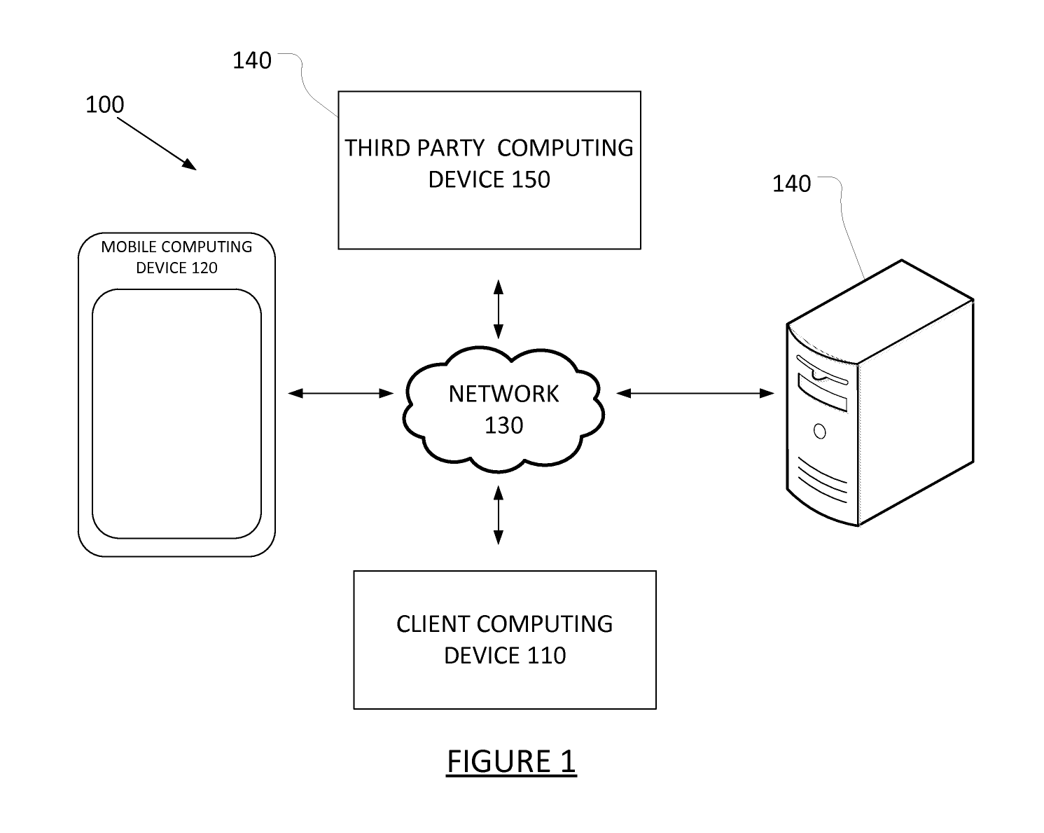

Turning now to FIG. 1, FIG. 1 depicts one topology for synchronizing data across datasets. Topology 100 may include a client computing device 110, mobile computing device 120, travel server 140, and third part computing device 150. The elements depicted in topology 100 may be communicatively coupled to each other over network 130.

Network 130 may be a wired or wireless network such as the Internet, an intranet, a LAN, a WAN, a NFC network, Bluetooth, infrared, radio frequency, a cellular network or another type of network. It will be understood that network 130 may be a combination of multiple different kinds of wired or wireless networks.

Client computing device 110 may be a laptop computer, desktop computer, smart phone, tablet computer, personal data assistant, or any other type of device with a hardware processor that is configured to process instructions and connect to network 130 and/or other forms of networks. Client computing device 110 may be configured to receive predetermined datasets from a user, and communicate the predetermined datasets to travel server 140.

Mobile computing device 120 may be a laptop computer, smart phone, tablet computer, personal data assistant, or any other type of mobile device with a hardware processor that is configured to process instructions and connect to network 130 and/or other forms of networks. Mobile computing device 140 may be configured receive real-time datasets from a user, communicate the real-time datasets to travel server 140, determine the location of mobile computing device 120, synchronize the real-time datasets with the predetermined sets based on time information and location information, and present information from third party computing device 150 responsive to synchronizing the datasets.

Travel server 140 may be a computing device, such as a general hardware platform server configured to support mobile applications, point of sale (POS) devices, software, and the like executed on client computing device 110 and/or mobile computing device 120. Travel server 140 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Travel server 140 may include any combination of one or more computer-usable or computer-readable media. For example, travel server 140 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

In embodiments, travel server 140 may be configured to receive a predetermined dataset from client computing device 110, a real-time dataset from mobile computing device 120, determine if the predetermined dataset and the real-time dataset should be synchronized based on time information and location information, and synchronize the datasets. Travel server 140 may also be configured to present content associated with the datasets to users of mobile computing device 120. The content presented to the users may be advertisements from third party computing device 150, wherein the advertisements are associated with the time information and/or location information for the datasets.

Third party computing device 150 may be a laptop computer, desktop computer, smart phone, tablet computer, personal data assistant, or any other type of device with a hardware processor that is configured to process instructions and connect to network 130 and/or other forms of networks. Third party computing device 150 may be configured to transmit media, such as audio media, text based media, visual media, etc. to travel server 140, wherein the media may be configured to be presented on mobile computing device 110. The media may be an advertisement associated with the location information and/or time information of both the predetermined dataset and real-time dataset. For example, the media may include an advertisement for a restaurant that is in close proximity to the location information associated with an event.

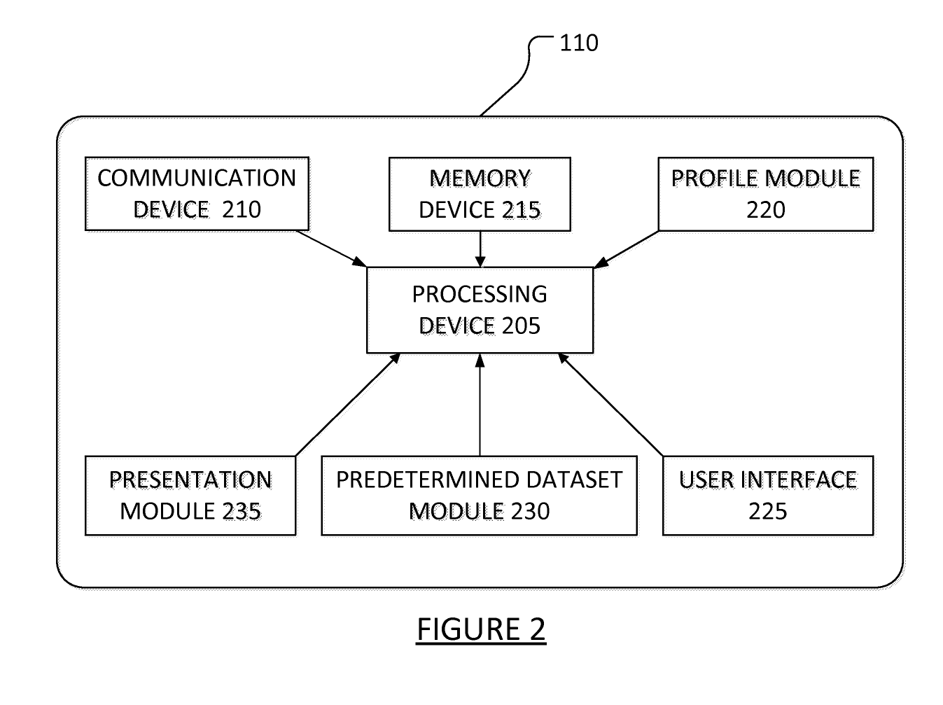

FIG. 2 depicts one embodiment of client computing device 110. Client computing device 110 may include processing device 205, communication device 210, memory device 215, profile module 220, user interface 225, predetermined dataset module 230, and presentation module 235.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of client computing device 110 or software associated with other elements of client computing device 110.

Communication device 210 may be a device that allows client computing device 110 to communicate with another device over network 130. Communication device 210 may include one or more wireless transceivers for performing wireless or wired communication. Communication device 210 may be configured to communicate data over a plurality of different standard and/or protocols.

Memory device 215 may be a device that stores data generated or received by client computing device 110. Memory device 215 may include, but is not limited to a hard disc drive, an optical disc drive, and/or a flash memory drive. In embodiments, memory device 215 may be configured to store information received from travel server 140, mobile computing device 120, and/or third party computing device 150. The information stored within memory device 215 may be accessed by processing device 205, communication device 210, user interface 225, and/or modules 220, 230, 235.

Profile module 220 may be a hardware processing device configured to allow the user of client computing device 110 to generate and create a user profile. A user's profile may include information stored in memory device 215 and/or other storage locations. A user's profile may include user information and social network information. The user information may include information identifying the user (e.g., a username or handle, number, identifier, and/or other identifying information), security login information (e.g., a login code or password), demographic information associated with users, or any other information associated with the user. The social network information may establish links between users based on relationships between users within an online community, wherein the online community may be associated with a group of users that desire to organize a trip together. Such travel groups may include one or more of friendships, connections, followers, and/or other relationships between users of an online community. Establishment of a travel group may be initiated by a single communication (e.g., a request) initiated by a first user (e.g. a trip planner) requesting a travel group be formed between the first user and one or more other users. Subsequently other users may be added to the travel group via requests from the users and/or the trip planner. In embodiments, the trip planner may transmit requests other users, such as friends on a social network, and to let the other users join the travel group. Responsive to the other users joining the travel group, the other users may be able to synchronize their own real-time dataset with a predetermined dataset created by the trip planner or any other user of the group. In embodiments, a predetermined dataset associated with a travel group may be synchronized with a real-time dataset associated with any user within the travel group.

User interface 225 may be a device that allows a user to interact with client computing device 1110, travel server 140, mobile computing device 120, or third party computing device 150 over network 130. While one user interface is shown, the term “user interface” may include, but is not limited to being, a touch screen, physical keyboard, mouse, camera, video camera, microphone, and/or speaker. Utilizing user interface 225, a user may perform actions to enter user profile information, generate a predetermined dataset, etc.

Predetermined dataset module 230 may be a hardware processing device configured to receive a predetermined dataset from a user, wherein the predetermined dataset is configured to be synchronized with a real-time dataset based on time information and location information. The predetermined dataset may be utilized by a tour guide or a user may provide content that they know they will like to be included in a journal, notebook, guide, etc. while visiting an event when they know they will be visiting the event. The predetermined dataset may be include a calendar of events, tasks, schedule, etc. (referred to herein after collectively and individually as a “schedule), wherein each event on a schedule may have corresponding content, time information, and/or location information.

The schedule for the predetermined dataset may be associated with any given day with a plurality of segments. For example, a schedule may include twenty-four segments corresponding to each hour of the day, segments corresponding to the time of the day (e.g. morning, middle of the day, afternoon, evening, etc.), etc. The schedule may also include a timestamp associated with when the predetermined dataset is created, and a timestamp associated with when the predetermined dataset is modified either by the user or by the predetermined dataset being synchronized with a real-time dataset.

The content may include information that the user or another user may desire to view at a later point in time (e.g. a segment of the schedule), such as notes associated with a location, map of a site, etc. In embodiments, each segment may have time information including a start time and a corresponding end time, wherein segments may be associated with a time period when a user desires to visit an event.

The time information may include a time period associated with the segment of the day that the user plans on visiting an event or POI. For example, a user may desire to visit a museum during a first segment of the schedule starting at 1:00 PM, continue to visit the museum during a second segment starting at 2:00 PM, and leave the museum at an end of the second segment at 3:00 PM. The time information for the second event may correspond to a time that the user desires to visit the second event after visiting a first event. For example, a user may desire to visit the first event during the first time segment, and two segments later (e.g. hours) desire to visit the second event.

The location information may include a location associated with the event. For example, the location information may be Cartesian coordinates of the location, a zip code, street address, etc. of the event.

Presentation module 235 may be a hardware processing device configured to present content (e.g. a predetermined dataset), profile information, etc. to a user of client computing device 110. Presentation module 235 may be configured to present content, profile information, etc. to a user on a display of client computing device 110.

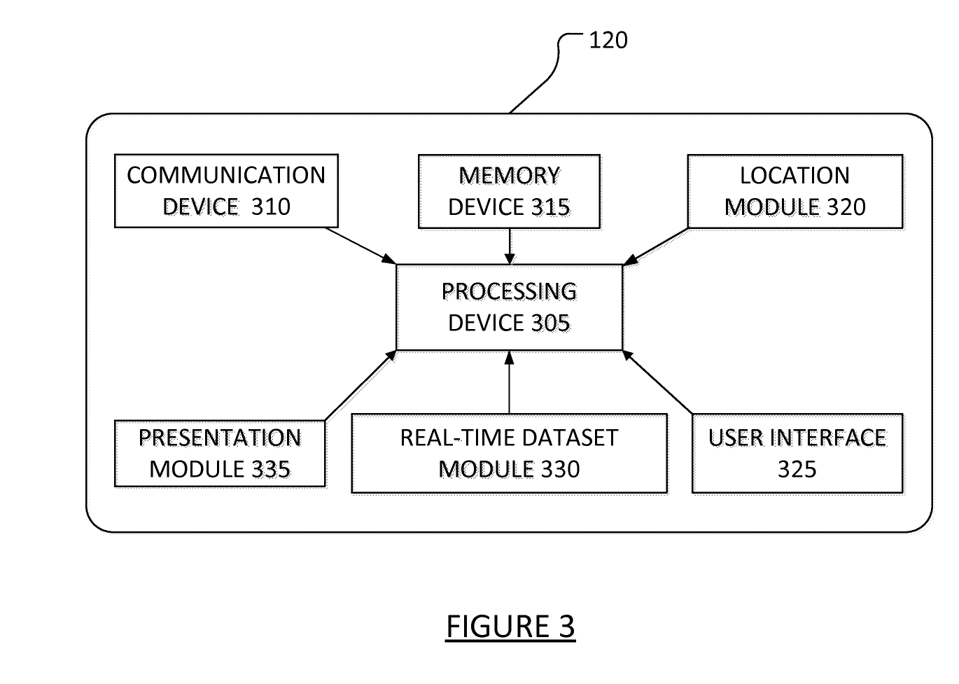

FIG. 3 depicts one embodiment of mobile computing device 120. Mobile computing device 120 may include processing device 305, communication device 310, memory device 315, location module 320, user interface 325, real-time dataset module 330, and presentation module 335.

Processing device 305 may include memory, e.g., read only memory (ROM) and random access memory (RAM), storing processor-executable instructions and one or more processors that execute the processor-executable instructions. In embodiments where processing device 305 includes two or more processors, the processors may operate in a parallel or distributed manner. Processing device 305 may execute an operating system of mobile computing device 120 or software associated with other elements of mobile computing device 120.

Communication device 310 may be a device that allows mobile computing device 120 to communicate with another device over network 130. Communication device 310 may include one or more wireless transceivers for performing wireless or wired communication. Communication device 310 may be configured to communicate data over a plurality of different standard and/or protocols.

Memory device 315 may be a device that stores data generated or received by mobile computing device 120. Memory device 315 may include, but is not limited to a hard disc drive, an optical disc drive, and/or a flash memory drive. In embodiments, memory device 315 may be configured to store information received from travel server 140, client computing device 110, and/or third party computing device 150. The information stored within memory device 315 may be accessed by processing device 305, communication device 310, user interface 325, and/or modules 320, 330, 335.

Location module 320 may be a hardware processing device configured to determine a location of mobile computing device 120. A location may be represented in geographic coordinates, Cartesian coordinates, e.g., an (x, y) point on a map if the map is divided into a Cartesian plane, and/or may be represented using reference points. Location module 320 may determine the location of mobile computing device 120 responsive to a user performing actions on user interface 325 to enter location information associated with the location of the mobile computing device 120, at set intervals, which may be any desired period of time (e.g., every 1/10^{th} of a second, every second, every minute, every ten minutes, etc.), responsive to a user creating a real-time dataset utilizing mobile computing device 120, or responsive to a segment of a predetermined dataset starting or ending. Location module 320 may determine the location of mobile computing device 120 via any known means, such as a RTLS WiFi, radar, mobile device tracking, time distance of arrival (TDOA) signals, short wave radio, Bluetooth, etc. Responsive to determining the location of the mobile computing device 120, location module 320 may transmit the location information to travel server 140. Furthermore, location module 320 may store, within an entry of a database within memory device 315, the location information and a corresponding timestamp identifying the time that the location of mobile computing device 120 is determined.

User interface 325 may be a device that allows a user to interact with mobile computing device 120, travel server 140, client computing device 110, or third party computing device 150 over network 130. While one user interface is shown, the term “user interface” may include, but is not limited to being, a touch screen, physical keyboard, mouse, camera, video camera, microphone, and/or speaker. Utilizing user interface 325, a user may perform actions to enter user profile information, generate a predetermined dataset, etc.

Real-time dataset module 330 may be a hardware processing device configured to receive a real-time dataset from a user, wherein the real-time dataset is configured to be synchronized with a predetermined dataset based on time information and location information. The real-time dataset may include content, time information, and location information.

The content may be notes, media (pictures, voice recordings, video recordings, etc.), feelings, blog posts, journal entries, etc. (referred to hereinafter individually and collectively as “content), which may be generated in real-time while a user is at an event. The content may also be generated on an interface that is independent to content within a predetermined dataset, such that the user may or may not have knowledge of the content within the predetermined dataset while the user is creating the real-time dataset.

The time information may include information a start time and an end time, wherein the start time may correspond to when the user begins creating the real-time dataset and/or when the user arrives at a location. The end time of the time information may correspond to when the user stops adding to the real-time dataset and/or leaves the location.

The location information may be the location information determined by location module 320, wherein the location information may be determined at set intervals, responsive to a user creating the real-time dataset, and/or at a segment of time corresponding to a schedule.

Presentation module 335 may be a hardware processing device configured to present content (e.g. a real-time dataset), profile information, etc. to a user of mobile computing device 120. Presentation module 335 may be configured to present content, location information, advertisements, etc. to a user on a display of client computing device 110.

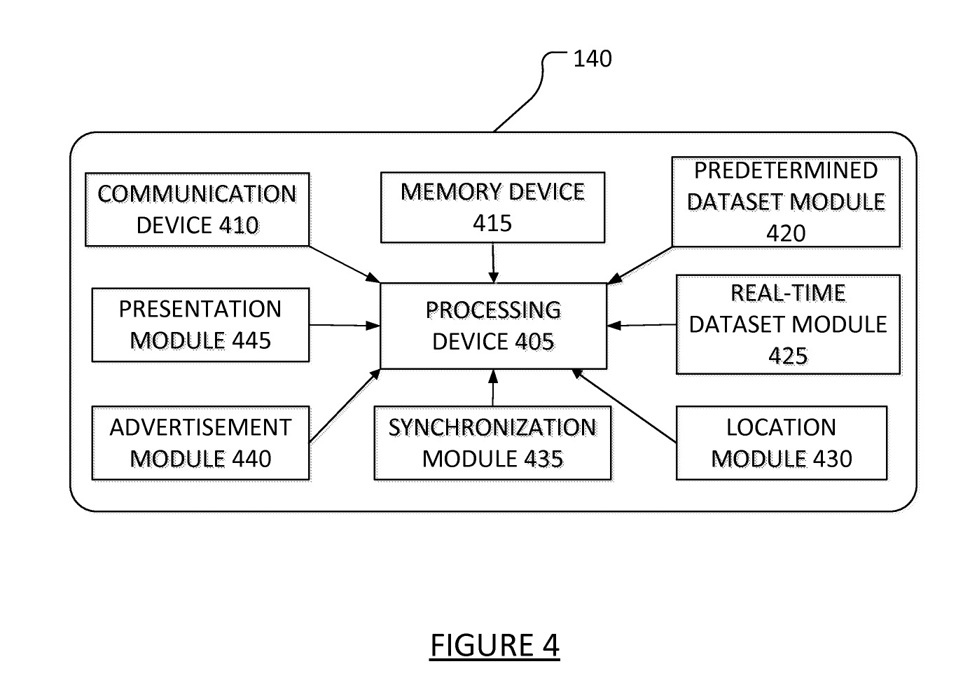

FIG. 4 depicts one embodiments of travel server 140. Travel server 140 may include processing device 405, communication device 410, memory device 415, predetermined dataset module 420, real-time dataset module 425, location module 430, synchronization module 435, advertisement module 440, and presentation module 445.

Processing device 405 may include memory, e.g., read only memory (ROM) and random access memory (RAM), storing processor-executable instructions and one or more processors that execute the processor-executable instructions. In embodiments where processing device 405 includes two or more processors, the processors may operate in a parallel or distributed manner. Processing device 305 may execute an operating system of travel server 140 or software associated with other elements of travel server 140.

Communication device 410 may be a device that allows travel server 140 to communicate with another device over network 130. Communication device 410 may include one or more wireless transceivers for performing wireless or wired communication. Communication device 410 may be configured to communicate data over a plurality of different standard and/or protocols.

Memory device 415 may be a device that stores data generated or received by travel server 140. Memory device 415 may include, but is not limited to a hard disc drive, an optical disc drive, and/or a flash memory drive. In embodiments, memory device 415 may be configured to store information received from client computing device 110, mobile computing device 120, and/or third party computing device 150. The information stored within memory device 415 may be accessed by processing device 405, communication device 410, user interface 425, and/or modules 420, 430, 435, 440, 445.

Predetermined dataset module 420 may be a hardware processing device configured to receive a predetermined dataset from client computing device 110. The predetermined dataset may include the information associated with the predetermined dataset and an identifier of the user or travel group associated with the predetermined dataset. Predetermined dataset module 420 may be configured to determine the schedule of the user based on the predetermined dataset. The schedule of the user may have a plurality of segments, wherein the number of segments may correspond to each hour of a day, time of the day (e.g. morning, middle of the day, afternoon, evening, etc.), etc. The segments may be associated with a time period when a user desires to visit an event or POI. In embodiments, the schedule may also have a timestamp associated with when the predetermined dataset is created, and a timestamp associated with when the predetermined dataset is modified either by the user or by the predetermined dataset being synchronized with a real-time dataset.

Real-time dataset module 425 may be a hardware processing device configured to receive a real-time dataset from a user and an identifier of a user associated with the real-time dataset, travel groups that the user is associated with, etc. The real-time dataset may also include content, time information, and location information.

Location module 430 may be a hardware processing device configured to determine the location of mobile computing device 120 generating a real-time dataset, and location module 430 may be determined to the location of an event within a segment of a predetermined dataset. Location module 430 may be configured to determine the location of mobile computing device 120 associated with a predetermined dataset and a real-time dataset responsive to receiving the real-time dataset, a schedule including a segment indicating that the user is about to attend an event, at set intervals, and/or the user performing actions on mobile computing device 120. Accordingly, if a predetermined dataset includes a segment indicating that the user is about to attend an event, location module 430 may determine if the user is at the event at the time of the event.

Synchronizer module 435 may be a hardware processing device configured to determine if a real-time dataset should be merged with a segment of a predetermined dataset. Synchronization module 435 may determine if the real-time dataset should be merged with the segment of a predetermined dataset based on the user identification information (which also may be an identification of a travel group), time information, location information associated with the segment of the predetermined dataset and the user identification information associated with the real-time dataset, time information associated with the real-time dataset, and location information associated with the real-time dataset.

In embodiments, if the user identification information, time information, and location information within a segment of a predetermined dataset matches the user information, time information (e.g. the time information associated with the real-time dataset is between the start time and end time for the segment), and location information with a real-time dataset, then the content associated with the real-time dataset may be merged with the content that was previously generated associated with the predetermined dataset. The merging of the datasets may maintain the content of both the predetermined dataset and the content of the real-time dataset, or the content of the real-time dataset may amend the content of the predetermined dataset. Furthermore, the real-time dataset and the segment of the predetermined dataset may be automatically synchronized together by synchronization module 435 based on the user identification, location information, and/or time information without receiving any commands from the user. Therefore, the user may not be required to perform actions to input commands to merge the datasets. In other embodiments, the user may be required to perform actions on mobile computing device 120 to synchronize the two datasets.

In embodiments, the real-time dataset synchronized with the segment of predetermined dataset may be synchronized such that other segments of predetermined dataset may not be updated, amended, or modified. To synchronize other content associated with other segments of the predetermined dataset, the user information, location information, and time information of the real-time dataset should match the user information, location information, and time information of another segment of the predetermined dataset.

Responsive to the segment of the predetermined dataset being synchronized with the real-time dataset, a timestamp associated with the segment of the predetermined dataset may be updated to include data indicating when the segment of the predetermined dataset was synchronized with a real-time dataset.

In embodiments, responsive to synchronization module 435 synchronizing a segment of a predetermined dataset with a real-time dataset, synchronization module 435 may flag the segment of the predetermined dataset to indicate that the segment is has been merged with a real-time dataset. Therefore, a user may be able to view a predetermined dataset and determined which segments have been updated or not updated based on the flags. Synchronization module 435 may also be configured to flag real-time datasets if they are merged with a segment of a predetermined dataset, such that if a real-time dataset is not merged with a segment of a predetermined dataset it will not be flagged.

Advertisement module 440 may be a hardware processing device configured to receive advertisements from third party computing devices 150, and present the advertisements to users on mobile computing devices 120. The advertisements may be presented to the user on mobile computing device 120 responsive to a real-time dataset being synchronized with a segment of a predetermined dataset. The advertisement presented to the user may be associated with the location information and/or time information, such that a retailer associated with the advertisement may be in close proximity to the location information. In embodiments, if a real-time dataset is synchronized with a segment of a predetermined dataset, then an advertisement may be presented to the user automatically, and if the real-time dataset is not synchronized with the segment of the predetermined dataset then an advertisement may not be presented to the user. This may be because if the real-time dataset and the segment of the predetermined dataset have conflicting location information, then the advertisement may not have location information corresponding to both the predetermined dataset and the real-time dataset.

Presentation module 445 may be a hardware processing device configured to transmit information to be presented on a display of mobile computing device 120 and/or client computing device 110. The transmitted information may correspond to synchronized datasets, location information, content, etc.

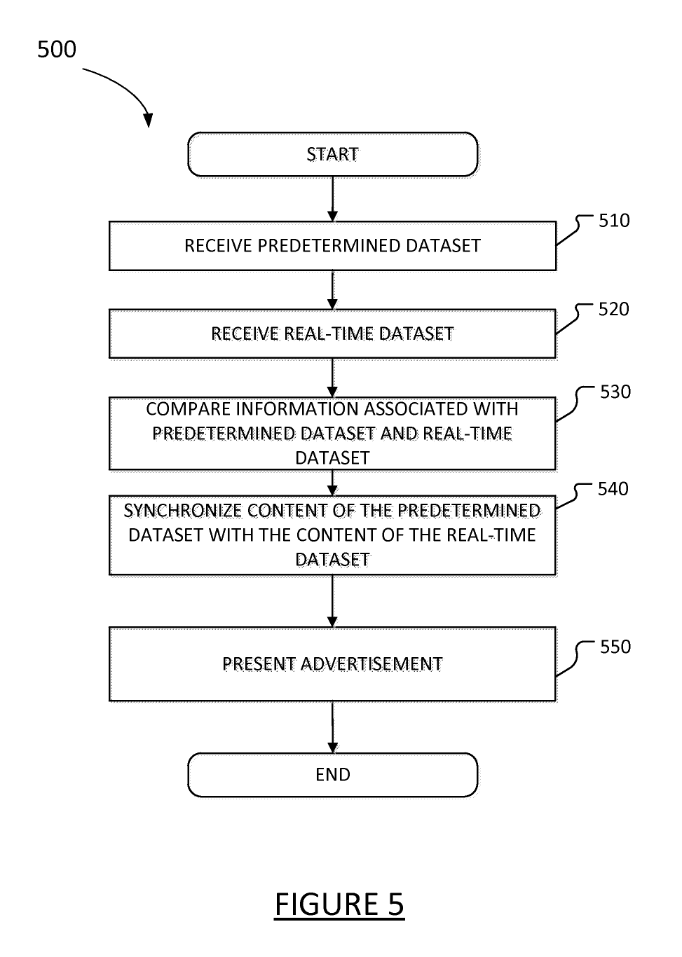

FIG. 5 illustrates a method 500 for synchronizing a real-time dataset with a segment of a predetermined dataset. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At operation 510, a predetermined dataset may be received. The predetermined dataset may include an identifier of the user associated with the predetermined dataset, content, location information, and time information. The identifier of the user may be a unique identifier associated with the user on a social network, a travel group that the user is part of on a social network, etc. The content may be created before the user arrives at the location associated with the location information and/or before a time period associated with the time information. Operation 510 may be performed by a predetermined dataset module that is the same as or similar to predetermined dataset module 420, in accordance with one or more implementations.

At operation 520, a real-time dataset may be received. The real-time dataset may include an identifier of the user associated with the real-time dataset, content that is dynamically generated by the user, location information associated with the current location of the user, and time information associated with the current time. Operation 520 may be performed by a real-time dataset module that is the same as or similar to real-time dataset module 425, in accordance with one or more implementations.

At operation 530, the user identification information, location information, and time information associated with the predetermined dataset may be compared with the user identification information, location information, and time information associated with the real-time dataset. Operation 530 may be performed by a synchronization module that is the same as or similar to synchronization module 435, in accordance with one or more implementations.

At operation 540, the content associated with the real-time dataset may be synchronized with the content of the predetermined dataset responsive to determining that the user identification information, location information, and time information associated with the predetermined dataset may be match the user identification information, location information, and time information associated with the real-time dataset. The content of the predetermined dataset may by synchronized with the content of the real-time dataset such that the real-time dataset may update, amend, supplement, etc. the predetermined dataset. Operation 540 may be performed by a synchronization module that is the same as or similar to synchronization module 435, in accordance with one or more implementations.

At operation 550, an advertisement associated with the location information corresponding to the predetermined dataset and the real-time dataset may be transmitted. The advertisement may be transmitted responsive to merging the content within the real-time dataset with the content within the predetermined dataset, wherein the advertisement is associated with the location of both datasets. Operation 550 may be performed by an advertisement module that is the same as or similar to advertisement module 440, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for synchronizing data, the system comprising:
a predetermined dataset module configured to receive a predetermined dataset, the predetermined dataset including a plurality of segments of time, wherein each segment of time includes first identification information, first content information, first location information, and first time information, wherein the first content information is generated before a user is located at a location associated with the first information and before a time associated with the first time information;
a real-time dataset module configured to receive a real-time dataset, the real-time dataset including second identification information, second content information, second location information, and second time information;
a synchronization module configured to merge the second content information with the first content information responsive to determining that the first identification information corresponds with the second identification information, first location information corresponds with the second location information, and the first time information corresponds with the second time information.

2. The system of claim 1, wherein each of the segments of time is associated with a point of interest, event, venue, or site that the user may visit during the first time information.

3. The system of claim 1, wherein the first time information includes a start time and an end time forming a first time interval, and the second time information corresponds with the first time interval when the second time information is within the first time interval.

4. The system of claim 1, wherein the second content information is generated while the user is at the location associated with the location information during a time associated with the second time information.

5. The system of claim 1, wherein each segment of time corresponds to an hour of a day.

6. The system of claim 1, wherein the synchronization module is configured to:
automatically, without receiving input from the user, merge the second content data with the first content data responsive to determining that the first identification information corresponds with the second identification information, first location information corresponds with the second location information, and the first time information corresponds with the second time information.

7. The system of claim 1, further comprising: an advertisement module configured to receive an advertisement, the advertisement including third location information.

8. The system of claim 7, wherein the advertisement module is configured to:
transmit the advertisement responsive to merging the second content data with the first content data.

9. The system of claim 1, wherein the predetermined dataset includes a creation timestamp associated with a time that the predetermined dataset is created.

10. The system of claim 1, wherein the predetermined dataset includes a synchronization timestamp associated with a time that the second content is merged with the first content.

11. A method for synchronizing data by a server over a network, the method comprising:
receiving, by a hardware processor, a predetermined dataset, the predetermined dataset including a plurality of segments of time, wherein each segment of time includes first identification information, first content information, first location information, and first time information, wherein the first content information is generated before a user is located at a location associated with the first information and before a time associated with the first time information;
receiving a real-time dataset, the real-time dataset including second identification information, second content information, second location information, and second time information;
merging the second content information with the first content information responsive to determining that the first identification information corresponds with the second identification information, first location information corresponds with the second location information, and the first time information corresponds with the second time information.

12. The method of claim 11, wherein each of the segments of time is associated with a point of interest, event, venue, or site that the user may visit during the first time information.

13. The method of claim 11, wherein the first time information includes a start time and an end time forming a first time interval, and the second time information corresponds with the first time interval when the second time information is within the first time interval.

14. The method of claim 11, further comprising:
generating the second content information while the user is at the location associated with the location information during a time associated with the second time information.

15. The system of claim 11, wherein each segment of time corresponds to an hour of a day.

16. The method of claim 11, further comprising:
merging automatically, without receiving input from the user, the second content data with the first content data responsive to determining that the first identification information corresponds with the second identification information, first location information corresponds with the second location information, and the first time information corresponds with the second time information.

17. The method of claim 11, further comprising:
receiving an advertisement, the advertisement including third location information.

18. The method of claim 17, further comprising:
transmitting the advertisement responsive to merging the second content data with the first content data.

19. The method of claim 11, wherein the predetermined dataset includes a creation timestamp associated with a time that the predetermined dataset is created.

20. The method of claim 11, wherein the predetermined dataset includes a synchronization timestamp associated with a time that the second content is merged with the first content.
